(19) United States
(12) Patent Application Publication
(10) Pub. No.: US 2004/0063409 A1
(43) Pub. Date: Apr. 1, 2004

(54) Method and arrangement for digitally receiving a signal

(76) Inventors: Konrad Boehm, Blaustein (DE); Johann-Friedrich Luy, Ulm (DE); Thomas Mueller, Ulm (DE); Harald Schnepp, Illertissen (DE)

Correspondence Address: DAVIDSON, DAVIDSON & KAPPEL, LLC, 485 SEVENTH AVENUE, 14TH FLOOR, NEW YORK, NY, 10018, US

(21) Appl. No.: 10/451,310

(22) PCT Filed: Dec. 4, 2001
(86) PCT No.: PCT/EP01/14183

(30) Foreign Application Priority Data
Dec. 22, 2000 (DE) 100 64 498.8

(51) Int. Cl. H04B 1/00

(52) U.S. Cl. 455/130; 455/132

(57) ABSTRACT

In order to improve the signal-to-noise ratio for broadcast radio reception in a vehicle, the invention provides an arrangement (1) for digital reception of a signal (S), in particular of a broadcast radio signal, having two or more antennas (2) each of which has an associated receiver element (4), with the receiver elements (4) being connected via a data bus (6) to a central control unit (8) for synchronization and superimposition of antenna signals (S) which are emitted from the antennas (4).

The invention relates to a method and an arrangement for digital reception of a signal, in particular of a broadcast radio signal in vehicles.

Receivers, in particular broadcast radio receivers in vehicles, are normally being increasingly designed in digital form. This has become possible in particular as a result of the major progress in the computation speed of signal processors and the performance of analog/digital converters (referred to as A/D converters in the following text). As an interface, the antenna in this case represents a limit to the reception quality. For example, if two or more antennas are connected to one another in order to improve the signal-to-noise ratio, the signals which are emitted from the antennas are superimposed. In this case, all the reception mixers are supplied via a radio-frequency cable, by means of a master oscillator. In the case of down-mixing, the signal from the master oscillator must be supplied to all the antenna base points, directly at the antenna. This has the disadvantage that the installation for clock distribution via a shielded radiofrequency cable is particularly complex and costly. A receiver such as this is thus generally unsuitable for use in a vehicle.

One object of the invention is thus to specify an arrangement for digital reception of a signal, in particular of a broadcast radio signal, with the signal-to-noise ratio being better than in the prior art. A further object of the invention is to specify a particularly suitable method.

The first-mentioned object is achieved according to the invention by an arrangement for digital reception of a signal, in particular of a broadcast radio signal, comprising two or more antennas each of which has an associated receiver element, with the receiver elements being connected via a data bus to a central control unit for synchronization and superimposition of antenna signals which are emitted from the antennas. Connecting two or more antennas to one another in this way, in particular to form a so-called antenna array, with two or more receiver elements or subreceivers, and coupling them to a central control unit makes it possible to superimpose the emitted antenna signals. This results in a particularly good signal-to-noise ratio, with the levels of undesirable signals being suppressed. In contrast to conventional solutions, the receiver elements are synchronized via a common data bus. In this case, it is possible to use the same data bus which is used by other digital systems in the vehicle, such as a navigation or position-finding system, or video system. A link such as this and the networking of the radio receiver with other systems in the vehicle via one and the same data bus, in particular via an optical data bus, result in particularly simple networking and wiring for the arrangement, without any additional complexity.

The or each receiver element expediently has an A/D converter for conversion of each analog antenna signal to a digital antenna signal. In consequence, the antenna signals are digitized in a preferred manner directly after the antenna, by means of the associated A/D converter in the receiver element. Depending on the nature and configuration of the arrangement, the receiver element has a mixer for mixing the digital antenna signal to form an intermediate frequency. If the central data bus is used not only for synchronization of the receiver elements, the receiver element preferably also has a local oscillator for a locally based clock supply.

The control unit is advantageously provided for coherent superimposition of the digitized antenna signals. In particular, this is made possible by the common synchronization of the individual receivers or receiver elements, and their phase-locked processing. The coherent superimposition of the received antenna signals and suitable weighting of these signals by means of the central control unit result in the antenna arrangement having a directional effect, which once again makes a contribution to the reception characteristics of the arrangement being as good as possible, in particular contributing to an improvement in the signal-to-noise ratio.

In one preferred refinement of the arrangement, the control unit is provided for central synchronization of the receiver elements using a master clock. The sampling and, possibly, the mixing that takes place before the sampling are thus synchronized via the same digital data bus, in particular an optical data bus. In this case, the receiver elements are preferably synchronized centrally on the basis of the master clock, such that the edges of the antenna signals or user data are evaluated.

The second-mentioned object is achieved according to the invention by a method for digital reception of a signal, in particular of a broadcast radio signal, in which antenna signals are emitted from two or more antennas, each of which has an associated receiver element, and are synchronized and superimposed via a data bus by means of a central control unit. In this case, the signals are superimposed in the central control unit such that the signal-to-noise ratio of the overall received signal is improved, or the level of undesirable signals is reduced. The digitized antenna signals are preferably superimposed coherently. Particularly at low frequencies (for example long wave, medium wave), the antenna signals and hence the antenna areas of the antenna array can be added directly, thus resulting in the reception performance being improved by the number of individual antennas, while at the same time improving the signal-to-noise ratio. To produce phase stability in the arrangement in addition to the direct clock supply by the master clock, each of the antenna signals is preferably oscillated by means of the associated receiver element to form an intermediate frequency.

The advantages that are achieved by the invention are, in particular, that the use of a common data bus, in particular of an optical data bus, for the synchronization, distribution and superimposition of the antenna signals which are emitted from two or more antennas and are received by means of associated receiver elements allows the reception quality to be improved in comparison to the prior art. A radio receiver of this type which is optically synchronized using an optical data bus has a particularly good signal-to-noise ratio. The use of a data bus allows the arrangement to be retrofitted, for example, even in existing vehicles with an existing data bus, without any additional wiring complexity.

Exemplary embodiments of the invention will be explained in more detail with reference to a drawing, in which:

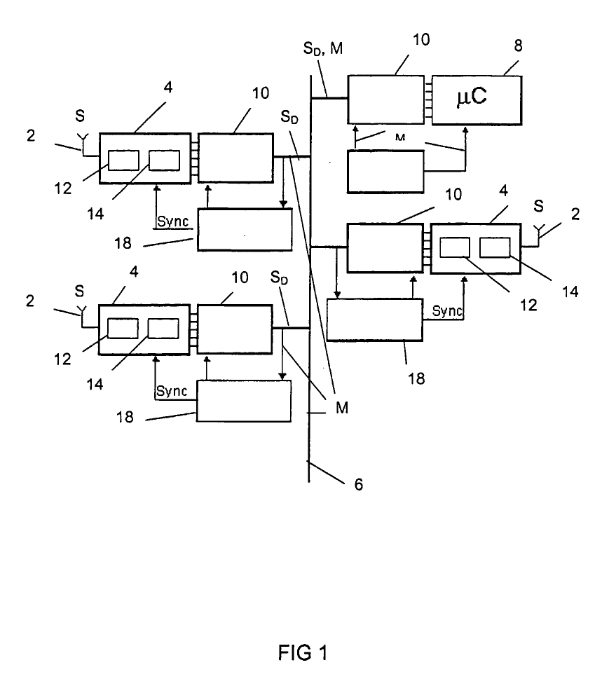

FIG. 1 shows, schematically, an arrangement for digital reception of a signal having two or more antennas and having two or more receiver elements which are coupled to a data bus, and

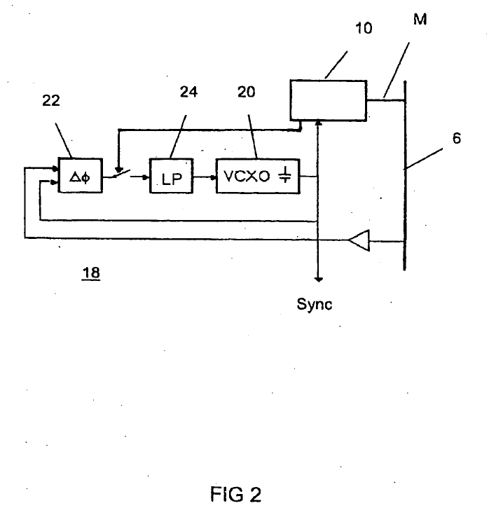

FIG. 2 shows, schematically, clock recovery for a receiver element as shown in FIG. 1.

Mutually corresponding parts are provided with the same reference symbols in all the figures.

FIG. 1 shows an arrangement 1 for digital reception (referred to in the following text as the receiver 1) of a signal S, in particular of a broadcast radio signal. The receiver 1 is, for example, a digital broadcast radio receiver in a vehicle. The receiver 1 has two or more antennas 2, and a number of receiver elements 4 corresponding to the number of antennas 2. The antennas 2 may in this case be connected in the form of an antenna array. The receiver elements 4 are connected to a central control unit 8 via a data bus 6. The control unit 8 is, for example, a microcontroller or a personal computer. An associated bus interface 10 is provided for coupling the respective receiver element 4 or the central control unit 8 to the data bus 6. An appropriate bus interface 10 is provided, depending on the nature and configuration of the data bus 6 or of the transmission medium. The data bus 6 is, for example, an optical transmission medium, for example an optical waveguide. Alternatively, a coaxial cable may be used as the transmission medium.

The analog antenna signal S which is emitted from the associated antenna 2 is digitized directly after the relevant antenna 2 by means of an analog/digital converter 12 (referred to as an A/D converter in the following text) in the respective receiver element 4. Alternatively, the antenna signal S can be digitized by means of the A/D converter 12 after a mixer stage 14. The digitized antenna signals S_{D}, which may also be digitally preprocessed by means of the receiver element 4, are sent via the data bus 6 to the central control unit 8. During the transmission of the antenna signals S_{D} to the central control unit 8, they are synchronized by means of a master clock M from a master module 16 in the control unit 8 via the same data bus 6. The receiver elements 4, in particular the sampling or, if appropriate, the mixing which is carried out by means of the mixer stage 14 before the sampling, is in this case synchronized on the basis of an evaluation of the edges of the digitized antenna signals S_{D}. In this case, the individual digital receiver elements 4 which are coupled to the data bus 6 are synchronized and operated in a phase-locked manner on the basis of a synchronization clock Sync, which is obtained from the master clock M. Alternatively or additionally, each receiver element 4 has a clock supply unit 18 for supplying the clock to the relevant receiver element 4. A local clock supply unit 18 such as this is used to support the clock supply if the master clock M in the central clock unit 8 fails and, if appropriate, for synchronization of the receiver elements 4 owing to the non-exclusive use of the data bus 6.

The digitized antenna signals S_{D} from the receiver elements 4 which are transmitted to the control unit 8 are coherently superimposed by means of the control unit 8 such that the signal-to-noise ratio of the received signal S is improved, or the levels of undesirable signals are suppressed. Coherent superimposition of the antenna signals S_{D} for frequencies whose wavelength is less than or equal to the order of magnitude of the distance between antennas results in a directional characteristic, with a signal-to-noise ratio which is still better. In addition, the digitized antenna signals S_{D} can be weighted by means of the control unit 8 in order to make it possible to produce a directional effect from an antenna system, for example an antenna array, which is formed from the antennas 2. Furthermore, the antenna areas can be added directly for low frequencies, for example long wave or medium wave. This results in the reception performance being improved by the number of antennas 4.

The requirements for interference channel suppression also result in the necessity for phase synchronicity for the entire arrangement 1. For example, assuming a reception frequency of 100 MHz and a signal-to-notch ratio of 10 dB, this results in time synchronicity of 318 ps for the antenna signals S, while a signal-to-notch ratio of 20 dB results in time synchronicity of 31.8 ps for the antenna signals S. Such time jitters are made possible in particular by a data bus 6 with a transmission medium with as broad a bandwidth as possible, for example an optical transmission medium.

The clock supply unit 18 for recovering the master clock M or synchronization clock is illustrated schematically in FIG. 2. The clock supply unit 18 is, for example, in the form of a phase locked loop (also referred to as a PLL, for short). The clock supply unit 18 has an oscillator 20, for example a crystal oscillator, a phase comparator 22, for example a multiplier, and a low-pass filter 24. Phase stability is achieved in the respective local clock supply unit 18 by means of the phase locked loop, in particular in the oscillator 20, depending on the protocol used for the data bus 6 and depending on the lack of a master clock M for providing a direct clock supply for the receiver elements 4. For this purpose, the input of the data is determined by the master clock M in the control unit 8 on the basis of the protocol, by means of the bus interface 10, and the phase locked loop for the clock supply unit 18 is closed, so that the oscillator 20 is synchronized to the master clock M. The oscillator 20 in the phase locked loop is in this case designed to produce a sufficient Allan variance for bridging the time in which no data, and thus no master clock M, is sent from the control unit 8, and in which the data bus 6 is used by other systems or services. A clock synchronization circuit such as this is thus used to bridge pauses in the transmission of the reference or master clock M, with the relevant receiver element 4 being synchronized on the basis of the held synchronization clock Sync.

1. An arrangement (1) for digital reception of a signal (S), in particular of a broadcast radio signal, comprising two or more antennas (2) each of which has an associated receiver element (4), with the receiver elements (4) being connected via a data bus (6) to a central control unit (8) for synchronization and superimposition of antenna signals (S) which are emitted from the antennas (4).

2. The arrangement as claimed in claim 1, in which the receiver element (4) has an A/D converter (12) for conversion of the respective analog antenna signal (S) to a digital antenna signal (S_{D}).

3. The arrangement as claimed in claim 1 or 2, in which the receiver element (4) has a mixer (14) for mixing the emitted antenna signal (S) to form an intermediate frequency.

4. The arrangement as claimed in one of claims 1 to 3, in which an oscillator (20) is provided for the clock supply for the associated receiver element (4).

5. The arrangement as claimed in one of claims 1 to 4, in which the control unit (8) is provided for coherent superimposition of the digitized antenna signals (S_{D}).

6. The arrangement as claimed in one of claims 1 to 5, in which the control unit (8) has a master module (16) for synchronization of the receiver elements (4) using a master clock (M).

7. A method for digital reception of a signal (S), in particular of a broadcast radio signal, in which antenna signals (S) are emitted from two or more antennas (2), each of which has an associated receiver element (4), and are synchronized and superimposed via a data bus (6) by means of a central control unit (8).

8. The method as claimed in claim 7, in which each of the antenna signals (S) are digitized by means of the associated receiver element (4).

9. The method as claimed in claim 7 or 8, in which each of the antenna signals (S) are mixed by means of the associated receiver element (4) to form an intermediate frequency.

10. The method as claimed in one of claims 7 to 9, in which the digitized antenna signals (S_{D}) are superimposed coherently.

11. The method as claimed in one of claims 7 to 10, in which the receiver elements (4) are synchronized centrally using a master clock (M).

12. The method as claimed in one of claims 8 to 11, in which the synchronization is carried out by evaluation of the edges of user data.
